(19) United States
(12) Patent Application Publication
(10) Pub. No.: US 2025/0137151 A1
(43) Pub. Date: May 1, 2025

(54) BOILER SYSTEM AND METHOD FOR OPERATING BOILER SYSTEM

(71) Applicant: MIURA CO., LTD., Matsuyama-shi Ehime (JP)

(72) Inventors: Masayuki YAMADA, Matsuyama-shi Ehime (JP); Soji SUMI, Matsuyama-shi Ehime (JP); Yusuke OKAMOTO, Matsuyama-shi Ehime (JP); Yoshiyuki YAMAMOTO, Matsuyama-shi Ehime (JP)

(21) Appl. No.: 18/835,539

(22) PCT Filed: Sep. 2, 2022
(86) PCT No.: PCT/JP2022/033142

§ 371 Date: Aug. 2, 2024

(30) Foreign Application Priority Data
Feb. 4, 2022 (JP) 2022-016221

(51) Int. Cl. C25B 15/021; C25B 1/04; C25B 9/67; F22B 1/00; F22D 1/02; F22D 1/16

(52) U.S. Cl. CPC C25B 15/021; C25B 1/04; C25B 9/67; F22D 1/02; F22D 1/16; F22B 1/00

(57) ABSTRACT

A boiler system (1) according to one aspect of the present invention includes a water electrolysis device (20) that electrolyzes electrolysis target water with electric power supplied from a natural energy power generation device (10) to generate hydrogen and oxygen, a boiler (30) that heats makeup water by combusting fuel to generate steam, a heat exchange device (40) that exchanges heat between the electrolysis target water and a heat medium, and a control device (70) having a cooling controller (71) that cools the electrolysis target water by supplying the makeup water as the heat medium to the heat exchange device when a preset cooling start condition is satisfied.

### TECHNICAL FIELD

The present invention relates to a boiler system and a method for operating a boiler system.

The present application claims priority based on Japanese Patent Application No. 2022-16221 filed in Japan on Feb. 4, 2022, the contents of which are incorporated herein by reference.

### BACKGROUND ART

In recent years, study has been conducted on use of hydrogen as fuel having a small environmental load. Particularly, for example, hydrogen produced by electrolyzing water with electric power generated from natural energy such as sunlight or wind power and other types of renewable energy has been called green hydrogen, and has attracted attention as fuel which does not emit carbon dioxide not only at the time of use but also in a production process.

Water electrolysis is generally performed by applying predetermined voltage and current to an electrode, and it is necessary to maintain the temperature of an electrolysis tank in a predetermined range in order to increase an energy efficiency in water electrolysis. On the other hand, e.g., solar power generation and wind power generation have such a characteristic that the amount of power generation fluctuates according to a natural condition, and the electrolysis amount and energy efficiency of a water electrolysis device using such electric power are affected thereby.

When a natural energy power generation device is connected to a power storage device in which a water electrolysis device and a fuel cell are combined, the power storage device is repeatedly started and stopped, and the temperature of the water electrolysis device or the fuel cell is decreased every time the power storage device is stopped. This leads to a problem that a system efficiency is degraded. Patent Literature 1 discloses that electrolytic water is heated by exhaust heat of a fuel cell to shorten the start-up time of a water electrolysis device and the fuel cell and to improve an efficiency.

### PRIOR ART LITERATURE

### Patent Literature

Patent Literature 1: JP-A-2010-67454

### DISCLOSURE OF THE INVENTION

### Problems to be Solved by the Invention

When hydrogen is produced by natural energy, a technique capable of maintaining a high electrolysis efficiency regardless of fluctuation in the natural energy has been demanded. Incidentally, a water electrolysis device generates heat during operation, and therefore, it is necessary to cool excessive heat and maintain the temperature of an electrolysis tank in a predetermined range and to heat and cool electrolysis target water of the water electrolysis device. In addition, natural energy converted into electricity by a natural energy power generator needs to be converted into hydrogen gas, oxygen gas, and heat by the water electrolysis device and such heat needs to be effectively utilized.

Accordingly, an object of the present invention is to provide a boiler system including a natural energy power generation device, a water electrolysis device, and a boiler and a method for operating the boiler system, which can suppress a decrease in the efficiency of the water electrolysis device and increase the heat efficiency of the boiler system even when the power generation amount of the natural energy power generation device fluctuates.

### Solution to the Problems

The present inventors et al. have arrived at the present invention in which by exchanging heat between a water electrolysis device and a boiler, it is possible to suppress a decrease in the efficiency of the water electrolysis device and enhance the heat efficiency of the boiler system even when the power generation amount of a natural energy power generation device fluctuates.

A boiler system according to one aspect of the present invention includes a water electrolysis device that electrolyzes electrolysis target water with electric power supplied from a natural energy power generation device to generate hydrogen and oxygen, a boiler that heats makeup water by combusting fuel to generate steam, a heat exchange device that exchanges heat between the electrolysis target water and a heat medium, and a control device having a cooling controller that cools the electrolysis target water by supplying the makeup water as the heat medium to the heat exchange device when a preset cooling start condition is satisfied.

A boiler system according to another aspect of the present invention includes a water electrolysis device that electrolyzes electrolysis target water with electric power supplied from a natural energy power generation device to generate hydrogen and oxygen, a boiler that heats makeup water by combusting fuel to generate steam, a heat exchange device that exchanges heat between the electrolysis target water and a heat medium, and a control device having a heating controller that heats the electrolysis target water by supplying hot fluid generated in the boiler as the heat medium to the heat exchange device when a preset heating start condition is satisfied.

In the above boiler system, at least any of the makeup water and the steam may be used as the hot fluid according to a condition.

In the above boiler system, the boiler may have an exhaust gas heat exchanger that exchanges heat between the makeup water and combustion exhaust gas, and the makeup water may be used as the hot fluid.

In the above boiler system, the boiler may combust, as fuel, hydrogen generated by the water electrolysis device.

In the above boiler system, the boiler may use, as oxygen for combustion, oxygen generated by the water electrolysis device.

In the above boiler system, the boiler may have a makeup water tank that stores the makeup water, and the boiler system may further include a makeup water return line through which the heat medium having exchanged heat with the electrolysis target water in the heat exchange device is introduced into the makeup water tank.

A method for controlling a boiler system according to one aspect of the present invention is a method for operating a boiler system including a water electrolysis device that electrolyzes electrolysis target water with electric power supplied from a natural energy power generation device to generate hydrogen and oxygen and a boiler that heats makeup water by combusting fuel to generate steam, the method including performing at least one of an operation of circulating the makeup water as the heat medium to a heat exchange device when a preset cooling start condition is satisfied or an operation of circulating hot fluid generated in the boiler as the heat medium to the heat exchange device when a preset heating start condition is satisfied.

### Effects of the Invention

According to the present invention, the boiler system and the method for operating the boiler system can be provided, which are capable of suppressing a decrease in the efficiency of the water electrolysis device and enhancing the heat efficiency of the boiler system.

### BRIEF DESCRIPTION OF THE DRAWINGS

FIG. 1 is a schematic diagram showing the configuration of a boiler system according to a first embodiment of the present invention.

### DESCRIPTION OF PREFERRED EMBODIMENTS

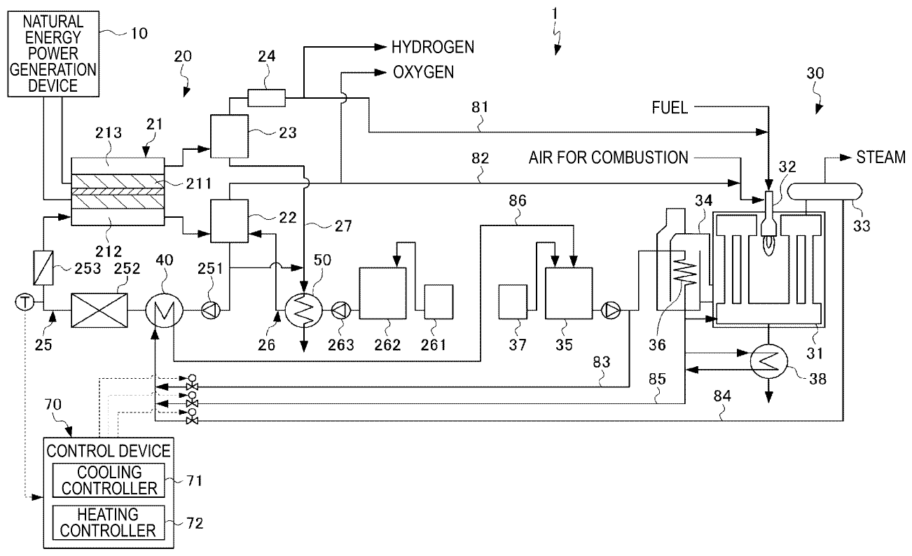

Hereinafter, an embodiment of the present invention will be described with reference to the drawings. FIG. 1 is a schematic diagram showing the configuration of a boiler system 1 according to the embodiment of the present invention.

The boiler system 1 includes a natural energy power generation device 10 that generates power by natural energy, a water electrolysis device 20 that electrolyzes electrolysis target water to generate hydrogen and oxygen, a boiler 30 that heats makeup water (boiler water) by combusting fuel to generate steam, a first heat exchange device 40 that exchanges heat between the electrolysis target water from the water electrolysis device 20 and a heat medium which is fluid obtained from the boiler 30, a second heat exchange device 50 that exchanges heat between the electrolysis target water discharged from the water electrolysis device 20 and the electrolysis target water newly supplied to the water electrolysis device 20, and a control device 70 that controls operation of the boiler system 1.

The natural energy power generation device 10 is a power generation device that converts natural energy into electric power, such as a solar power generation device or a wind power generation device. The output of the natural energy power generation device 10 fluctuates due to fluctuation in the natural energy. The natural energy power generation device 10 supplies the electric power to the water electrolysis device 20.

The water electrolysis device 20 electrolyzes the electrolysis target water with the electric power supplied from the natural energy power generation device 10 to generate hydrogen and oxygen. As the water electrolysis device 20, for example, a solid polymer electrolyte membrane (PEM) water electrolysis device or an alkaline water electrolysis device can be used, but in the present embodiment, the water electrolysis device 20 will be described as using the solid polymer electrolyte membrane water electrolysis device. The solid polymer electrolyte membrane water electrolysis device 20 includes a water electrolysis module 21 that electrolyzes the electrolysis target water to generate oxygen and hydrogen, an oxygen separator 22 that separates oxygen from the electrolysis target water discharged together with oxygen, a hydrogen separator 23 that separates hydrogen from the electrolysis target water discharged together with hydrogen, a dehumidifier 24 that removes moisture from hydrogen having passed through the hydrogen separator 23, a resupply line 25 through which the electrolysis target water recovered by the oxygen separator 22 is resupplied to the water electrolysis module 21, a pure water resupply line 26 through which pure water as electrolysis target water is resupplied to the oxygen separator 22, and a discharge line 27 through which part of the electrolysis target water flowing through the resupply line 25 and the electrolysis target water recovered by the hydrogen separator 23 are discharged to the outside of the system.

The water electrolysis module 21 can be configured such that an internal space is divided, by a membrane electrode assembly (MEA) 211 in which a solid polymer electrolyte membrane through which hydrogen ions and water permeate and a pair of electrodes are integrated, into a positive electrode chamber 212 to which the electrolysis target water is supplied and a negative electrode chamber 213 into which water and hydrogen ions flow from the positive electrode chamber 212 through the membrane electrode assembly 211. Oxygen is generated from the positive electrode chamber 212 by electrolysis, and hydrogen is generated from the negative electrode chamber 213 by electrolysis. The oxygen separator 22 and the hydrogen separator 23 can be formed by well-known gas-liquid separators. As the dehumidifier 24, a well-known dehumidifier can also be used.

The resupply line 25 includes the resupply pump 251 that pumps the electrolysis target water and an ion exchange device 252 and a filter 253 for ensuring the water quality of the electrolysis target water. In the resupply line 25, the first heat exchange device 40 for exchanging heat between the electrolysis target water and the heat medium obtained from the boiler 30 is disposed. When electrolysis is performed by the water electrolysis device 20, heat is generated in the water electrolysis module 21, and the electrolysis target water is heated. By adjusting the temperature of the electrolysis target water in the first heat exchange device 40, the temperature of the electrolysis target water supplied to the water electrolysis module 21 can be maintained at a temperature at which an electrolysis efficiency in the water electrolysis module 21 is high, such as 60° C. or more and 80° C. or less or 80° C. or more and 120° C. or less.

The pure water resupply line 26 has a pure water device 261 that produces pure water used as the electrolysis target water, a pure water tank 262 that stores the pure water, and a pure water pump 263 that delivers the pure water. In the pure water resupply line 26, the second heat exchange device 50 for recovering heat from the discharged electrolysis target water by heat exchange between the pure water newly supplied as the electrolysis target water and the electrolysis target water discharged from the water electrolysis device 20 to the outside of the system is disposed. For example, cooling water may be supplied to the second heat exchange device 50 or a heat exchange device separately provided in the pure water resupply line 26 to cool the pure water resupplied as the electrolysis target water, so that the temperature of the electrolysis target water supplied to the water electrolysis module 21 can be decreased.

The boiler 30 has a can body 31 that houses boiler water, a burner 32 that combusts fuel to heat the can body 31, a steam header 33 that stores steam flowing out of the can body 31, a gas duct 34 that leads out combustion exhaust gas from the burner 32, a makeup water tank 35 that stores the makeup water to be used as the boiler water in the can body 31, an exhaust gas heat exchanger 36 that heats the makeup water by heat exchange between the makeup water delivered from the makeup water tank 35 and the combustion exhaust gas, a soft water device 37 that produces soft water to be used as the makeup water and supplies the soft water to the makeup water tank 35, and a blow heat exchanger 38 that heats the makeup water by heat exchange among the makeup water delivered from the makeup water tank 35, the boiler water, and blow water (part of the boiler water) discharged from the can body 31. The makeup water tank 35 may be configured to maintain the temperature of the stored makeup water within a certain range (for example, 55° C. or more and 60° C. or less) by, for example, introduction of steam.

The boiler 30 can supply cold fluid for cooling the electrolysis target water and hot fluid for heating the electrolysis target water as the heat medium which exchanges heat with the electrolysis target water in the first heat exchange device 40. Specifically, the boiler 30 is capable of delivering, as the cold fluid, the makeup water supplied to the can body 31 through the exhaust gas heat exchanger 36 from, for example, the outlet side of the soft water device or the makeup water tank 35 to the first heat exchange device 40 and delivering, as the hot fluid, the makeup water heated by the exhaust gas heat exchanger 36 and the makeup water heated by the blow heat exchanger 38 to the first heat exchange device 40. Thus, the boiler system 1 includes a cold makeup water supply line 83 through which the pre-heated makeup water is led out from the boiler 30 and supplied to the first heat exchange device 40 and a hot makeup water supply line 85 through which the makeup water heated by at least one of the exhaust gas heat exchanger 36 or the blow heat exchanger 38 is led out from the boiler 30 and supplied to the first heat exchange device 40.

When the makeup water of the boiler 30 is supplied for cooling the electrolysis target water, the makeup water of the boiler 30 is supplied as cooling fluid to the boiler 30 after heat has been recovered from the electrolysis target water in the first heat exchange device 40, so that heat generated by electrolysis can be effectively used and the energy efficiency of the boiler system 1 can be enhanced. When the makeup water heated by the exhaust gas heat exchanger 36 and/or the blow heat exchanger 38 is supplied for heating the electrolysis target water, the makeup water heated by the exhaust gas heat exchanger 36 and/or the blow heat exchanger 38 heats, as the hot fluid, the electrolysis target water in the first heat exchange device, and the temperature of the electrolysis target water supplied to the water electrolysis module 21 can be controlled to the temperature at which the electrolysis efficiency is high. As described above, the boiler 30 acts as a heat buffer for the water electrolysis device 20 so that the electrolysis efficiency of the water electrolysis device 20 can be enhanced, a heat loss to the outside of the boiler system 1 can be reduced, and the energy efficiency can be enhanced.

The boiler 30 can also supply steam generated in the boiler 30 as the hot fluid for heating the electrolysis target water in the first heat exchange device 40. The steam is stored in the steam header 33, and is delivered to the first heat exchange device 40 by a steam supply line 84. The first heat exchange device may be provided separately for makeup water and steam.

The boiler system 1 further includes a makeup water return line 86 through which the makeup water having exchanged heat with the electrolysis target water is recovered from the first heat exchange device 40 and is introduced into the makeup water tank 35. By recovering the heat medium from the first heat exchange device 40 to the makeup water tank 35, the temperature of the electrolysis target water of the water electrolysis device 20 can be optimized by the makeup water tank 35 serving as a water and heat buffer even in a case where there is no water supply request from the boiler, such as a case where combustion in the boiler is stopped, and a case where the required amount of heat medium of the water electrolysis device 20 and the load of the boiler 30 do not match, such as a case where the amount of combustion in the boiler 30 is small and the makeup water required amount of the first heat exchange device is equal to or greater than the combustion amount. In addition, in a boiler system in which feed water heating (for example, introduction of steam) for a makeup water tank is performed in order to, e.g., prevent corrosion, makeup water circulates through the makeup water tank and a first heat exchange device, whereby electrolysis target water is heated at the time of start of a water electrolysis device and the electrolysis target water is cooled and heat is recovered to the makeup water tank at the time of active water electrolysis. That is, the makeup water of the boiler can be the hot fluid which heats the electrolysis target water when the temperature of the electrolysis target water is low, and can be the cold fluid which cools the electrolysis target water when the temperature of the electrolysis target water is high. Accordingly, the configuration for heating the makeup water can be omitted or simplified, and the amount of heat can be reduced. Further, when the heat recovery amount of the first heat exchanger is sufficiently great, hot water of 80° C. to 90° C. can be taken out from the outlet of the first heat exchange device 40.

The first heat exchange device 40 only needs to exchange heat between the electrolysis target water and the above-described heat medium, and may be a well-known heat exchanger. The second heat exchange device 50 only needs to exchange heat between the electrolysis target water newly supplied to the water electrolysis device 20 and the electrolysis target water discharged from the hydrogen separator 23 of the water electrolysis device 20, and may be a well-known heat exchanger.

The control device 70 is a device that automatically executes one embodiment of a boiler system control method according to the present invention, and controls the supply of the heat medium from the boiler 30 to the first heat exchange device 40 by, e.g., opening and closing a valve of each flow path. Specifically, the control device 70 includes a cooling controller 71 that cools the electrolysis target water by supplying, as the heat medium, the makeup water of the boiler 30 to the first heat exchange device 40 when a preset cooling start condition is satisfied, and a heating controller 72 that heats the electrolysis target water by supplying, as the heat medium, the hot fluid generated in the boiler 30 to the first heat exchange device 40 when a preset heating start condition is satisfied.

The control device 70 may include a physical circuit having, e.g., a relay, and may also be implemented in such a manner that a computer device including, e.g., a memory and a CPU executes an appropriate control program. Note that the cooling controller 71 and the heating controller 72 are classified according to the function of the control device 70, and are not necessarily clearly distinguished in a physical configuration and a program configuration.

By maintaining the temperature of the electrolysis target water at a first set temperature or less by the cooling controller 71, the electrolysis efficiency can be maintained in an appropriate range while, e.g., thermal degradation of the water electrolysis device 20 is reduced, and the fuel consumption of the boiler 30 can be reduced by heating of the makeup water. By maintaining the temperature of the electrolysis target water at a second set temperature or more by the heating controller 72, the electrolysis efficiency of the water electrolysis device 20 can be improved.

The cooling start condition for the cooling controller 71 typically includes a condition where the temperature of the electrolysis target water in the resupply line 25 is the first set temperature or more (upper temperature limit). In addition, the cooling start condition may include a condition where an operation condition for the natural energy power generation device 10, such as a solar irradiation in solar power generation or a wind intensity and duration, such as a wind speed, in wind power generation, satisfies a predetermined condition. When a third heat exchange device (not shown) is provided for heat utilization in the resupply line, the condition may include a condition where the load (heat recovery) of the third heat exchange device reaches a predetermined upper limit. When any of these conditions is satisfied, the cooling controller 71 supplies the makeup water, which is the cold fluid, from the boiler 30 to the first heat exchange device 40.

The heating start upper limit for the heating controller 72 typically includes a condition where the temperature of the electrolysis target water in the resupply line 25 is the second set temperature or less (lower temperature limit). In addition, the heating start condition may include, for example, a condition where the water electrolysis device 20 is restarted after having been stopped for a predetermined time or more and a condition where the operation condition for the natural energy power generation device 10 satisfies a predetermined condition. When the electrolysis target water is heated using the makeup water as the hot fluid, the heating controller 72 may issue a command for the boiler 30 to increase the flow rate of the makeup water supplied from the makeup water tank 35 to the exhaust gas heat exchanger 36 in order to prevent a decrease in the amount of water supplied to the can body 31.

The heating controller 72 may select at least any of the makeup water and the steam according to a condition, and use the makeup water and/or the steam as the hot fluid. For example, when the temperature of the electrolysis target water in the resupply line 25 is equal to or higher than a third set temperature which is lower than the second set temperature, the makeup water may be used as the hot fluid, and when the temperature of the electrolysis target water is lower than the third set temperature, steam having a greater heat amount may be used as the hot fluid. By doing so, even when the temperature of the electrolysis target water is low, the temperature can be made equal to or higher than the predetermined temperature in a short time, and the water electrolysis efficiency can be enhanced.

Further, the heating controller 72 may cause the boiler 30 to forcibly blow water when the electrolysis target water for, e.g., the water electrolysis device 20 is heated because the predetermined condition is satisfied. In this manner, the makeup water having a sufficient amount of heat can be supplied to the first heat exchange device 40, and therefore, the efficiency of the water electrolysis device 20 at the time of, e.g., start can be reliably improved. Furthermore, the blow heat exchanger 38 is preferably disposed near the can body 31.

The boiler 30 can combust, as fuel, hydrogen generated by the water electrolysis device 20 alone or in combination with another type of fuel. Further, the boiler 30 can use, as oxygen for combustion, oxygen generated by the water electrolysis device 20 alone or in combination with air. Thus, the boiler system 1 includes a hydrogen supply line 81 through which hydrogen is supplied from the water electrolysis device 20 to the boiler 30, and an oxygen supply line 82 through which oxygen is supplied from the water electrolysis device 20 to the boiler 30. By using hydrogen generated by the water electrolysis device 20 as fuel, a carbon emission amount in the boiler 30 can be reduced. Furthermore, by using oxygen generated by the water electrolysis device 20 as oxygen for combustion, an exhaust gas volume can be reduced so that the boiler efficiency can be improved.

A method for operating a boiler system, which is implemented for the boiler system 1, is a method for operating a boiler system including a water electrolysis device 20 that electrolyzes electrolysis target water with electric power supplied from a natural energy power generation device 10 to generate hydrogen and oxygen and a boiler 30 that heats makeup water by combustion of fuel to generate steam. When a preset cooling start condition is satisfied, an operation of circulating the makeup water as a heat medium to a first heat exchange device 40 is performed to exchange heat between the electrolysis target water and the makeup water. In the boiler system operation method, when a preset heating start condition is satisfied, an operation of circulating, as a heat medium, hot fluid generated in the boiler 30 to the first heat exchange device 40 is performed to exchange heat between the electrolysis target water and the hot fluid generated in the boiler 30. Thus, by exchanging heat between the water electrolysis device 20 and the boiler 30, it is possible to suppress a decrease in the efficiency of the water electrolysis device 20 and to enhance the heat efficiency of the boiler system 1 even when the power generation amount of the natural energy power generation device 10 fluctuates. The boiler system operation method may be manually implemented by an operator without the control device 70.

As described above, by exchanging heat between the water electrolysis device 20 and the boiler 30 in the boiler system 1, it is possible to suppress a decrease in the efficiency of the water electrolysis device 20 and to enhance the heat efficiency of the boiler system 1 even when the power generation amount of the natural energy power generation device 10 fluctuates. More specifically, in the boiler system 1, the cooling controller 71 and the heating controller 72 appropriately control heat exchange in the first heat exchange device 40 that exchanges heat between the electrolysis target water of the water electrolysis device 20 and the heat medium supplied from the boiler 30, so that the temperature of the electrolysis target water can be maintained within an appropriate range and the efficiency of the water electrolysis device 20 can be improved. Thus, the natural energy can be efficiently used.

Although each embodiment of the present invention has been described above, the present invention is not limited to the above-described embodiments, and various changes and modifications can be made. As an example, the boiler system according to the present invention does not necessarily include the natural energy power generation device, and may use electric power supplied from an external natural energy power generation device.

The boiler system according to the present invention only needs to include at least any of the cooling controller and the heating controller. In the present invention, the boiler system having the heating controller only needs to heat electrolysis target water with arbitrary hot fluid obtained in the boiler. Such a boiler system may be configured to supply only any of the steam and the makeup water as the hot fluid to the heat exchange device, or may be configured to directly supply blow water as the hot fluid to the heat exchange device. A heat exchanger for the makeup water may be independently provided upstream of the resupply line, and a heat exchanger for the steam may be independently provided downstream of the resupply line, so that the electrolysis target water can be further heated by the steam after having been heated by the makeup water. Accordingly, it is possible to shorten a time until the temperature reaches the set temperature, for example, when the temperature of the electrolysis target water is increased at the time of cold start, and it is possible to enhance the system efficiency.

In the exhaust gas heat exchanger, the system (boiler water supply pump, boiler water supply exhaust gas heat exchanger, and boiler water supply pipe) that heats the makeup water and supplies the makeup water to the boiler and the system (heat medium delivery pump, heat medium delivery exhaust gas heat exchanger, and heat medium delivery pipe) that supplies water to the first heat exchange device may be independently provided, and the makeup water heated by the exhaust gas heat exchanger may be supplied to the first heat exchange device via a pressure release tank (e.g., makeup water tank). Accordingly, the supply pressure of the makeup water to the first heat exchange device can be controlled regardless of the pressure of the can body.

Furthermore, in the boiler system according to the present invention, the flow path configuration of the water electrolysis device and the position of the heat exchange device can be appropriately changed based on common technical knowledge.

### LIST OF REFERENCE NUMERALS

1 Boiler System
10 Natural Energy Power Generation Device
20 Water Electrolysis Device
21 Water Electrolysis Module
211 Membrane Electrode Assembly
212 Positive Electrode Chamber
213 Negative Electrode Chamber
22 Oxygen Separator
23 Hydrogen Separator
24 Dehumidifier
25 Resupply Line
251 Resupply Pump
252 Ion Exchange Device
253 Filter
26 Pure Water Resupply Line
261 Pure Water Device
262 Pure Water Tank
263 Pure Water Pump
27 Discharge Line
30 Boiler
31 Can Body
32 Burner
33 Steam Header
34 Gas Duct
35 Makeup Water Tank
36 Exhaust Gas Heat Exchanger
37 Pure Water Device
38 Blow Heat Exchanger
40 First Heat Exchange Device
50 Second Heat Exchange Device
70 Control Device
71 Cooling Controller
72 Heating Controller
81 Hydrogen Supply Line
82 Oxygen Supply Line
83 Cold Makeup Water Supply Line
84 Steam Supply Line
85 Hot Makeup Water Supply Line
86 Makeup Water Return Line

1. A boiler system comprising:
a water electrolysis device that electrolyzes electrolysis target water with electric power supplied from a natural energy power generation device to generate hydrogen and oxygen;
a boiler that heats makeup water by combusting fuel to generate steam;
a heat exchange device that exchanges heat between the electrolysis target water and a heat medium; and
a control device having a cooling controller that cools the electrolysis target water by supplying the makeup water as the heat medium to the heat exchange device when a preset cooling start condition is satisfied.

2. A boiler system comprising:
a water electrolysis device that electrolyzes electrolysis target water with electric power supplied from a natural energy power generation device to generate hydrogen and oxygen;
a boiler that heats makeup water by combusting fuel to generate steam;
a heat exchange device that exchanges heat between the electrolysis target water and a heat medium; and
a control device having a heating controller that heats the electrolysis target water by supplying hot fluid generated in the boiler as the heat medium to the heat exchange device when a preset heating start condition is satisfied.

3. The boiler system according to claim 2, wherein at least any of the makeup water and the steam is used as the hot fluid according to a condition.

4. The boiler system according to claim 3, wherein
the boiler has an exhaust gas heat exchanger that exchanges heat between the makeup water and combustion exhaust gas, and
the makeup water is used as the hot fluid.

5. The boiler system according to claim 1, wherein the boiler combusts, as fuel, hydrogen generated by the water electrolysis device.

6. The boiler system according to claim 1, wherein the boiler uses, as oxygen for combustion, oxygen generated by the water electrolysis device.

7. The boiler system according to claim 1, wherein
the boiler having a makeup water tank that stores the makeup water, further comprising:
a makeup water return line through which the heat medium having exchanged heat with the electrolysis target water in the heat exchange device is introduced into the makeup water tank.

8. A method for operating a boiler system including
a water electrolysis device that electrolyzes electrolysis target water with electric power supplied from a natural energy power generation device to generate hydrogen and oxygen,
a boiler that heats makeup water by combusting fuel to generate steam, and
a heat exchange device that exchanges heat between the electrolysis target water and a heat medium, the method comprising:
performing at least one of an operation of circulating the makeup water as the heat medium to the heat exchange device when a preset cooling start condition is satisfied or an operation of circulating hot fluid generated in the boiler as the heat medium to the heat exchange device when a preset heating start condition is satisfied.

9. The boiler system according to claim 2, wherein the boiler combusts, as fuel, hydrogen generated by the water electrolysis device.

10. The boiler system according to claim 3, wherein the boiler combusts, as fuel, hydrogen generated by the water electrolysis device.

11. The boiler system according to claim 4, wherein the boiler combusts, as fuel, hydrogen generated by the water electrolysis device.

12. The boiler system according to claim 2, wherein the boiler uses, as oxygen for combustion, oxygen generated by the water electrolysis device.

13. The boiler system according to claim 3, wherein the boiler uses, as oxygen for combustion, oxygen generated by the water electrolysis device.

14. The boiler system according to claim 4, wherein the boiler uses, as oxygen for combustion, oxygen generated by the water electrolysis device.

15. The boiler system according to claim 5, wherein the boiler uses, as oxygen for combustion, oxygen generated by the water electrolysis device.

16. The boiler system according to claim 9, wherein the boiler uses, as oxygen for combustion, oxygen generated by the water electrolysis device.

17. The boiler system according to claim 9, wherein
the boiler having a makeup water tank that stores the makeup water, further comprising:
a makeup water return line through which the heat medium having exchanged heat with the electrolysis target water in the heat exchange device is introduced into the makeup water tank.

18. The boiler system according to claim 10, wherein
the boiler having a makeup water tank that stores the makeup water, further comprising:
a makeup water return line through which the heat medium having exchanged heat with the electrolysis target water in the heat exchange device is introduced into the makeup water tank.

19. The boiler system according to claim 6, wherein
the boiler having a makeup water tank that stores the makeup water, further comprising:
a makeup water return line through which the heat medium having exchanged heat with the electrolysis target water in the heat exchange device is introduced into the makeup water tank.

20. The boiler system according to claim 12, wherein
the boiler having a makeup water tank that stores the makeup water, further comprising:
a makeup water return line through which the heat medium having exchanged heat with the electrolysis target water in the heat exchange device is introduced into the makeup water tank.

21. The boiler system according to claim 13, wherein
the boiler having a makeup water tank that stores the makeup water, further comprising:
a makeup water return line through which the heat medium having exchanged heat with the electrolysis target water in the heat exchange device is introduced into the makeup water tank.
